(19) United States
(12) Patent Application Publication
(10) Pub. No.: US 2005/0044086 A1
(43) Pub. Date: Feb. 24, 2005

(54) Symmetry database system and method for data processing

(76) Inventors: Cheng-Hwa Liu, Hsinchu City (TW); Chin-Hsuen Chen, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/643,241

(22) Filed: Aug. 18, 2003

(51) Int. Cl. G06F 17/00

(52) U.S. Cl. 707/100

(57) ABSTRACT

A symmetry database system and method for data processing. The system includes a data source, a data preparation platform, and a plurality of process engines. In one embodiment, the separated business rules and the data preparation process of each process engine are integrated into the data preparation platform to avoid problems of asymmetry. The process engines are further configured to fetch data from the symmetry data source through a data generator and generate results according to the data.

### BACKGROUND OF THE INVENTION

1. Field of the Invention

The present invention relates to database management, and particularly to a database system and method for data processing with multiple processes and databases.

2. Description of the Related Art

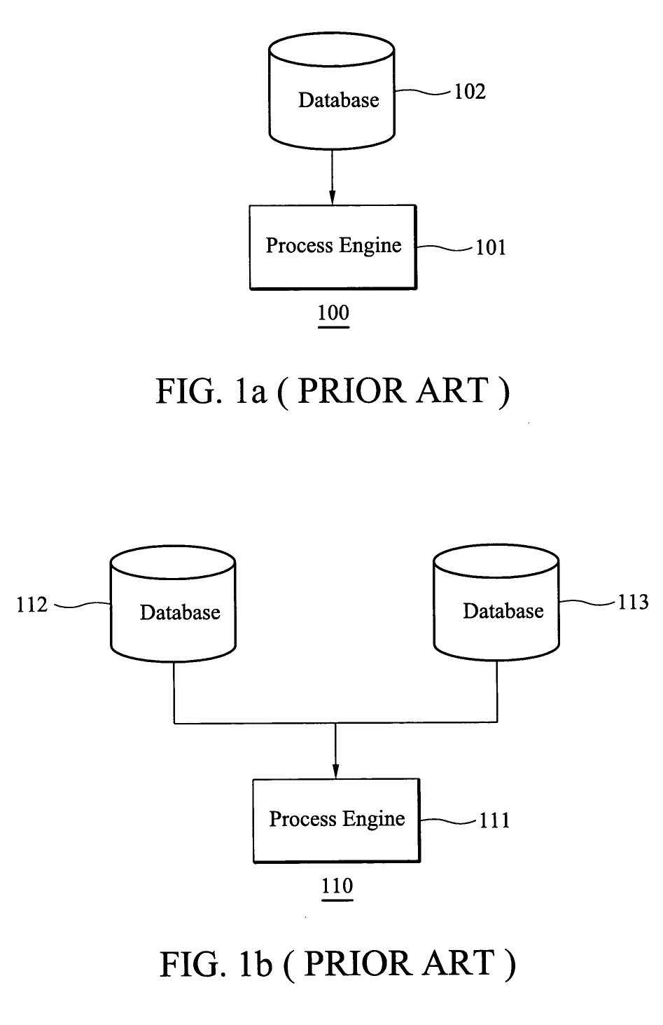

Databases are widely used in the IT (information technology). In general, a data processing system may employ a single process engine to access the database and perform business rules and operations of the process engine. FIGS. 1a and 1b show two data processing systems as known. In FIG. 1a, the data processing system 100 includes a process engine 101 and a database 102. In a manner that is known, the process engine 101 performs required business rules and operations using the data in the database 102. Likewise, in the known database system of FIG. 1b, the data processing system 110 includes a process engine 111 and two databases 112 and 113, and the process engine 111 accesses the data in the databases 112 and 113 and performs required business rules and operations to generate results.

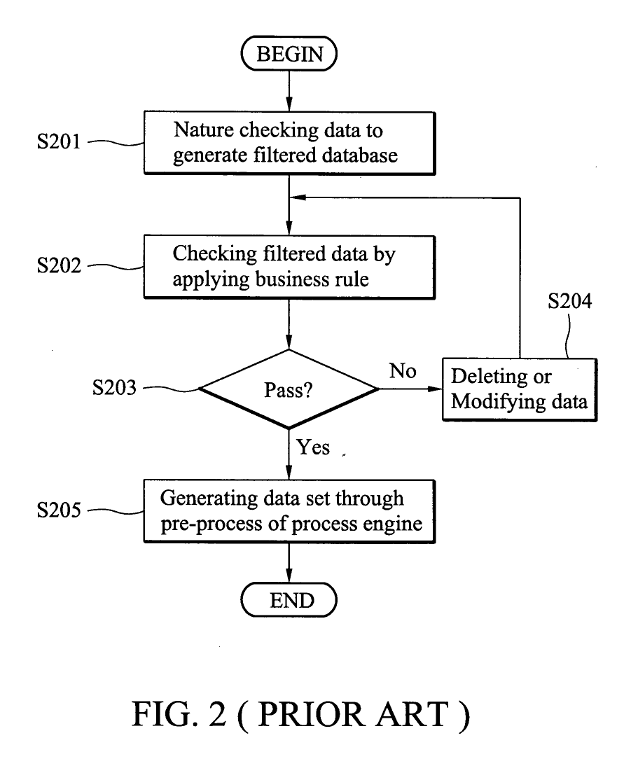

Before the data is used by the process engine, a process of data preparation is performed, as shown in FIG. 2. First, in step S201, the data in the database is nature-checked. Nature-checking, as used herein, refers to the filtering of data violating prescribed formats for the system, thereby generating a filtered database. Then, in step S202, the filtered data in the filtered database is further checked by applying the business rules of the process engine for the system. The elements and processes shown in FIGS. 1a, 1b, and 2 are known, and therefore need not be further described herein.

If the filtered data does not pass the business rules (No in step S203), in step S204, the filtered data may be deleted or modified and returned to step S202 for further checking. If yes (Yes in step S203), in step S205, the data sets used by the process engine are generated through a pre-process of the process engine. After data preparation, the process engine may perform required business rules and operations using the data set, and generate results. In data processing systems with a single process engine and single or multiple databases, it is easy to develop and maintain systems and applications for IT administrators.

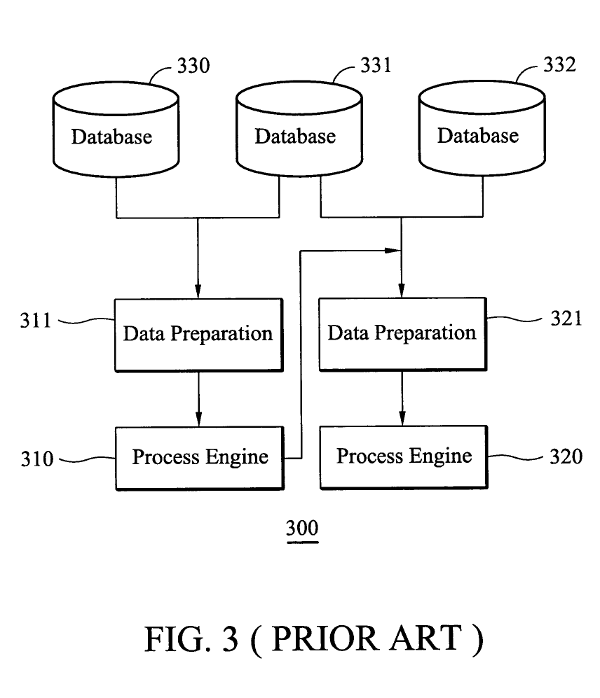

FIG. 3 illustrates a data processing system with serial data process engines. The data processing system 300 includes two process engines 310 and 320, and three databases 330, 331, and 332. The process engine 310 has its own data preparation process 311 to filter and generate data sets from the databases 330 and 331, and uses the data sets to generate results. The results of the process engine 310 are sent to the process engine 320. Similarly, the process engine 320 has its own data preparation process 321 to filter and generate data sets from the results of the process engine 310 and the databases 330 and 331, and uses the data sets to generate results.

In the above data processing system, since each database can be used by different process engines and each process engine has its own data preparation process, the results of the most recent process engine and the data prepared by the data preparation process of the subsequent process engine may be non-symmetric. The term “non-symmetric” means that the data set output by the most recent process engine does not conform the data set collected by the subsequent process engine, that is the data sets are different in quantity, the items in the data sets are different, and others.

Since the engines of the data processing system are serially operated, the symmetry concern of the data in different databases is an important issue since the data processing system frequently experience engine crashes or result errors due to asymmetry of data between databases. Further, when a process engine crashes or result errors occur in real time, there is no effective mechanism to notify IT administrators, and it is difficult and time-consuming to identify the problem. The conventional work flow for single process engine with multiple databases is unavailable for serial process with multiple databases.

### SUMMARY OF THE INVENTION

It is therefore an object of the present invention to provide a symmetry database system and method for data processing with multiple processes and databases, so as to avoid engine crashes and result errors caused by symmetry database.

It is another object of the present invention to provide an early detection mechanism to discover and repair from problems of asymmetry in real time.

To achieve the above and other objects, the present invention provides a symmetry database system and method for data processing in the system. The system includes a data source, a data preparation platform, and a plurality of process engines. In one embodiment, the separated business rules and the data preparation process of each process engine are integrated into the data preparation platform to avoid problems of asymmetry. The process engines are further configured to fetch data from the symmetry data source through a data generator and generate results according to the data.

In one embodiment, the data preparation platform filters source data from the data source into a symmetry data source, in which the data source comprises a plurality of databases. In this embodiment, the symmetry data source comprises a plurality of symmetry databases, and the data preparation platform filters data from the plurality of databases into corresponding symmetry databases.

In accordance with one embodiment of the invention, the filtering method of the data preparation platform aligns the data in the data source is aligned to link the databases. Then, the aligned data is nature-checked. Afterward, the aligned data is checked by applying business rules of the process engines to filter the data that does not pass the business rules, and the aligned data is filtered using a flexible filter, so as to generate the symmetry data source.

A data alignment method of the data preparation platform preferably lists primary keys of source tables in the data source, and finds popular items according to the frequency of the primary keys in the source tables and the business rules of the process engines. Thereafter, at least one critical item from the popular items is found, such that the databases in the data source can be linked using the critical item.

Further, the system includes an application interface and a monitor unit. The application interface allows users to access the data source in real time. The monitor unit monitors the access of data source through the application interface, and notifies related IT administrators if the process engine crashes or result errors occur. BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1a is a schematic diagram illustrating the architecture of a data processing system with a single engine and database as known in the prior art;

FIG. 1b is a schematic diagram illustrating the architecture of a data processing system with a single engine and multiple database as known in the prior art;

FIG. 2 is a flowchart showing the process of data preparation of the process engine as known in the prior art;

FIG. 3 is a schematic diagram illustrating the architecture of a data processing system with multiple engines and databases as known in the prior art;

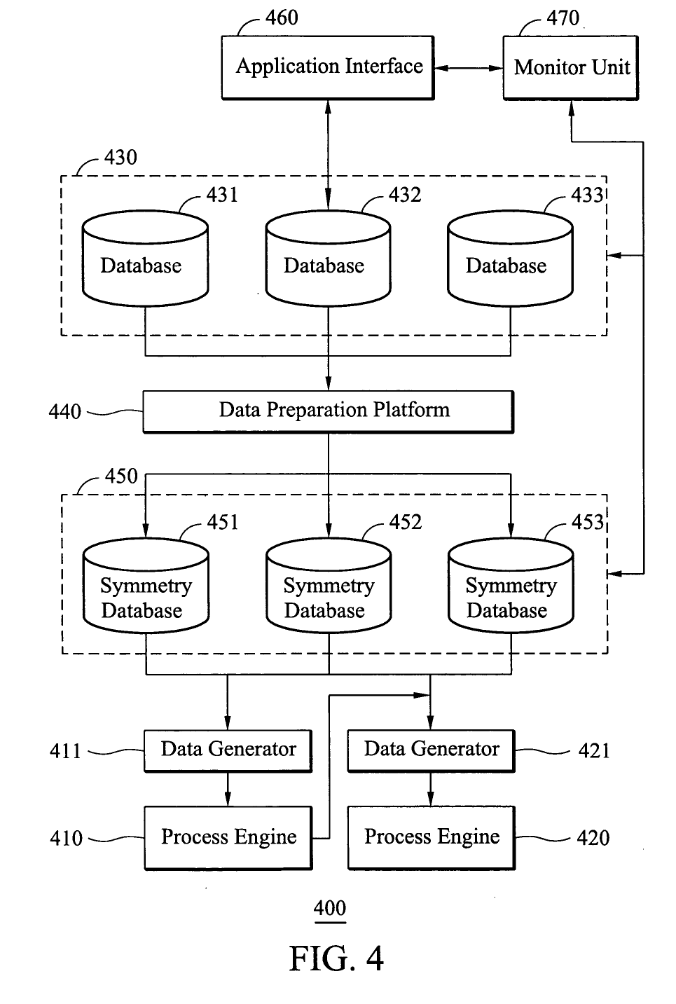

FIG. 4 is a schematic diagram illustrating an architecture of the symmetry database system for a data processing system according to an embodiment of the present invention;

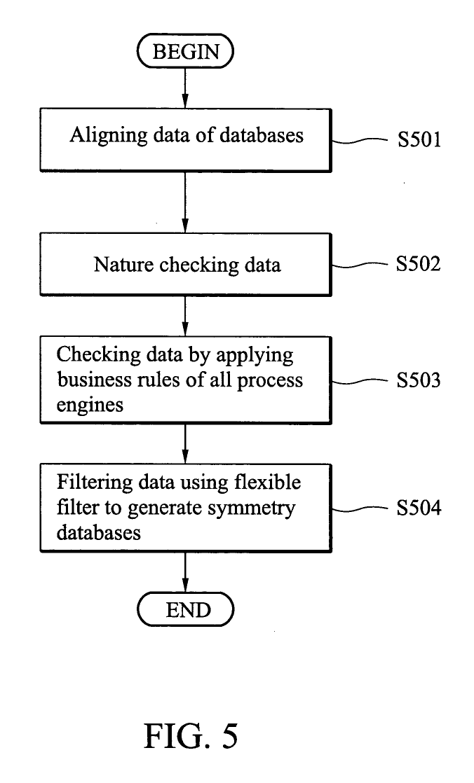

FIG. 5 is a flowchart showing a process of the symmetry database method for a data processing system according to an embodiment of the present invention;

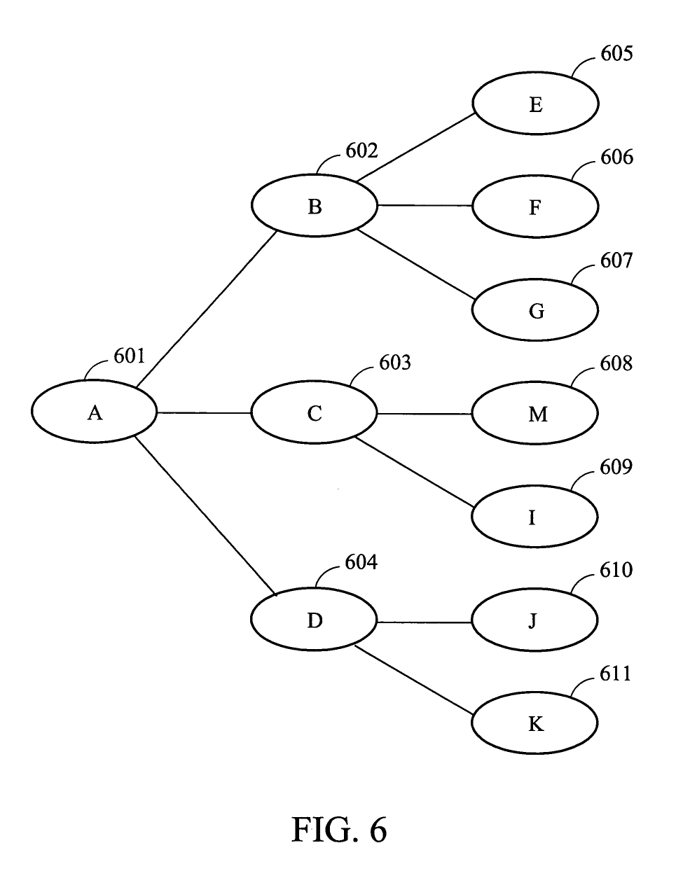

FIG. 6 is a schematic diagram illustrating the relationship between source tables and critical items; and

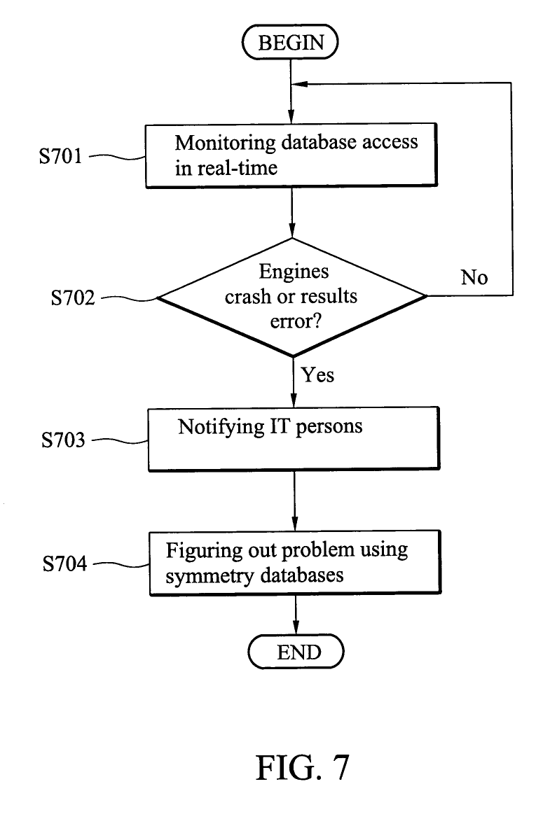

FIG. 7 is a flowchart showing a monitoring process of the monitor unit 470 according to an embodiment of the present invention.

### DETAILED DESCRIPTION OF THE INVENTION

FIG. 4 illustrates the architecture of the symmetry database system for a data processing system according to one embodiment of the present invention. The illustrated embodiment is suitable for use in data processing systems with serial process engines involving several processes and databases.

For example, a supply chain management system is a serial data processing system with multiple processes and databases. Supply chains exist in both service and manufacturing organizations, although the complexity of the chain may vary greatly from industry to industry and firm to firm. To strengthen competitive ability, supply chain management has become an important issue, to meet the goals of reduced inventory and increased productivity. A supply chain management system includes several process engines, such as capacity management engine, application management engine, order management engine, ATP (available to promise) engine, order planning engine, and others to manage and perform materials purchasing, transformation of the materials into intermediate and finished products, and the distribution of the finished products to customers.

The symmetry database system 400 for a data processing system, according to an embodiment of the present invention, includes two process engines 410 and 420, with the results of the process engine 410 forwarded to the process engine 420. The process engine 410 has a data generator 411 to generate the data sets needed by the process engine 410 through a pre-process of the process engine 410. Additional features and aspects of the data generator 411 will be described later herein. Similarly, the process engine 420 has a data generator 421 to generate the data sets needed by the process engine 420 through a pre-process of the process engine 420. Note that the pre-processes are rules to collect data samples, dependent upon the process engines.

The symmetry database system 400 also includes a data source 430 including databases 431, 432 and 433. In a supply chain management system, these databases may be an order database, WIP (Work In Process) database, product information database, technology information database, customer information database, and/or other information database.

The symmetry database system 400 further includes a data preparation platform 440 to check and filter the data in the data source 430 into symmetry data source 450 as the symmetry databases 451, 452 and 453. It should be noted that the purpose of the data preparation platform 440 is to integrate the separated business rules and the data preparation process of each process engines into a single unit, so as to avoid problems of asymmetry. The operations of the data preparation platform will be further described immediately below with reference to FIG. 5.

FIG. 5 shows the process of the symmetry database method of the data preparation platform 440 according to one embodiment of the present invention. First, in step S501, the data in the databases is aligned.

One data alignment method comprises listing the primary keys of the source tables in the data source 430 to find more popular items according to the corresponding frequency in the source tables and the business rules of the process engine 410 and 420. Then, at least one critical item is found in the popular items.

In one case, the critical item can be found using an experience rule, for example, according to dynamic data, such as ordering, WIP to find the critical item. In the case of supply chain management, the popular items may include fab code, customer code, part ID, product body, technology code, and others, and the critical items may be one or some of the popular items, such as the part ID and the others.

Reference is made briefly to FIG. 6 to illustrate the relationship between source tables and critical items. In FIG. 6, symbols 601 to 611 represent source tables in the data source 430, and the symbols A to K represent the key of the corresponding source table, in which A, B, C and D are the critical items. It should be noted that the critical items can link all the source tables in the data source 430, and once all the source tables are linked, the modification and deletion for symmetry can be easily and quickly accomplished.

Returning to FIG. 5, after the step of data alignment, in step S502, the data in the data source 430 is nature-checked, and in step S503, the data is further checked by applying the business rules of the process engines to filter the data that does not pass the business rules. Further, a flexible filter is provided in the data preparation platform 440. The flexible filter may be an application or interface provided for users to edit conditions, so as to gather or filter data needed by the process engine. Therefore, in step S504, the data is filtered using the flexible filter to generate symmetry data source 450 comprising the databases 451, 452 and 453.

Based on the organization and symmetry of the data in the symmetry data source 450, the data generator 411 may readily collect and generate the data sets needed by the process engine 410 from the symmetry data source 450, and the results of the process engine 410 are forwarded to the process engine 420. Similarly, the data generator 421 may collect and generate the data sets needed by the process engine 420 from the symmetry data source 450.

Further, the symmetry database system 400 also includes an application interface 460 and a monitor unit 470. The application interface is an interface provided for users to access the data source 430 in real time. The monitor unit 470 monitors the access situation of the data source 430 through the application interface 460.

FIG. 7 shows the monitoring process of the monitor unit 470 according to one embodiment of the present invention. First, in step S701, the monitor unit 470 monitors the real-time access of the databases. If one engine of the system crashes or plan result is in error (Yes in step S702), in step S703, the monitor unit 470 may notify related IT administrators via beeper, telephone, email, or other means. Afterward, the monitor unit 470 automatically helps IT administrators to identify and repair the problem corresponding to the engine crash or result errors according to the data source and the aligned symmetric database.

Further, the system according to the present invention has adjustment capability. For example, after nature checking and the filtering of business rules in the data preparation platform 440, the dirty data can be summarized to check and modify the databases. In addition, the result generated by the process engine and the data filtered in the data preparation platform 440 can check and modify the business rules in the data preparation platform 440.

As a result, using the symmetry database system and method for data processing according to the present invention, engine crashes and result errors caused by symmetry database can be more effectively avoided. Further, problems resulting from asymmetry in real time can be detected early and repaired in an effective manner.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A symmetry database system for a data processing system, comprising:
a data source for storing source data;
a data preparation platform to filter the source data into a symmetry data source; and
a plurality of process engines to fetch data from the symmetry data source and generate results according to the data.

2. The symmetry database system as claimed in claim 1 wherein the data source comprises a plurality of databases, the symmetry data source comprises a plurality of symmetry databases, and the data preparation platform filters data from the plurality of databases into corresponding symmetry databases.

3. The symmetry database system as claimed in claim 2 wherein the filtering operation of the data preparation platform is carried out by elements comprising:
logic for aligning data in the data source to link the databases in the data source;
logic for nature-checking the aligned data; and
logic for checking the aligned data by applying business rules of the process engines to filter the data that does not pass the business rules, so as to generate the symmetry data source.

4. The symmetry database system as claimed in claim 3 wherein the filtering operation of the data preparation platform is carried out by an element comprising logic for filtering the aligned data using a flexible filter to generate the symmetry data source.

5. The symmetry database system as claimed in claim 3 wherein the data alignment operation of the data preparation platform is carried out by elements comprising:
logic for listing primary keys of source tables in the data source;
logic for finding popular items according to a frequency of the primary keys in the source tables and the business rules of the process engines; and
logic for finding at least one critical item from the popular items, whereby the databases in the data source can be linked using at least one the critical item.

6. The symmetry database system as claimed in claim 1 further comprising a plurality of data generators corresponding to each process engine to fetch the data needed by each process engine from the symmetry data source.

7. The symmetry database system as claimed in claim 1 further comprising an application interface to provide users with access to the data source in real time.

8. The symmetry database system as claimed in claim 7 further comprising a monitor unit to monitor access of the data source through the application interface, and notify administrators or other responsible parties if a process engine crashes or result errors occur.

9. The symmetry database system as claimed in claim 8 wherein the monitor unit further identifies and repairs problems corresponding to process engine crashes or result errors according to the data source and the symmetry data source.

10. The symmetry database system as claimed in claim 1 wherein the process engines are serial data process engines.

11. A symmetry database method for a data processing system, comprising the steps of:
providing a data source for storing source data;
filtering the source data into a symmetry data source using a data preparation platform; and
fetching data from the symmetry data source by a plurality of process engines, and generating results according thereto.

12. The symmetry database method as claimed in claim 11 wherein the data source comprises a plurality of databases, the symmetry data source comprises a plurality of symmetry databases, and the data preparation platform filters data from the plurality of databases into corresponding symmetry databases.

13. The symmetry database method as claimed in claim 12 wherein the filtering method of the data preparation platform comprises:
aligning data in the data source to link the databases in the data source;
nature-checking the aligned data; and
checking the aligned data by applying business rules of the process engines to filter the data that does not pass the business rules, so as to generate the symmetry data source.

14. The symmetry database method as claimed in claim 13 wherein the filtering method of the data preparation platform further comprising filtering the aligned data using a flexible filter to generate the symmetry data source.

15. The symmetry database method as claimed in claim 13 wherein the data alignment method of the data preparation platform comprises:
listing primary keys of source tables in the data source;
finding popular items according to a frequency of the primary keys in the source tables and the business rules of the process engines; and
finding at least one critical item from the popular items, by which the databases in the data source can be linked.

16. The symmetry database method as claimed in claim 11 wherein the data needed by each process engine is fetched from the symmetry data source by a corresponding data generator.

17. The symmetry database method as claimed in claim 11 further allowing users to access the data source in real time.

18. The symmetry database method as claimed in claim 17 further monitoring accesses of the data source in real time, and notifying administrators or other responsible parties if a process engine crashes or result errors occur.

19. The symmetry database method as claimed in claim 18 further identifying and repairing problems corresponding to process engine crashes or result errors according to the data source and the symmetry data source.

20. The symmetry database system as claimed in claim 11 wherein the process engines are serial data process engines.
